(19) United States
(12) Patent Application Publication
(10) Pub. No.: US 2012/0110748 A1
(43) Pub. Date: May 10, 2012

(54) WASHING ADDITIVE CLOTH COMPRISING BLEACH

(75) Inventors: Peter Schmiedel, Dusseldorf (DE); Danilo Panzica, Haan (DE); Francesca Corbellini, Koln (DE); Gabriele Hürtgen, Dusseldorf (DE); Matthias Sunder, Dusseldorf (DE)

(73) Assignee: Henkel AG & Co. KGaA, Dusseldorf (DE)

(21) Appl. No.: 13/354,404

(22) Filed: Jan. 20, 2012

Related U.S. Application Data
(63) Continuation of application No. PCT/EP2010/060568, filed on Jul. 21, 2010.

(30) Foreign Application Priority Data
Jul. 24, 2009 (DE) 10 2009 028 002.2

(51) Int. Cl. D06L 1/20; B05D 3/02; B05D 3/00; B32B 5/02

(52) U.S. Cl. 8/137; 442/130; 427/372.2; 427/398.1

(57) ABSTRACT

The present invention relates to a washing additive article comprising a water-insoluble textile substrate, and to a washing additive composition comprising a bleaching agent present in solidified form on the substrate. In order to fix the bleaching agent particles, the washing additive composition comprises a film-forming polymer.

### CROSS-REFERENCE TO RELATED APPLICATIONS

This application is a continuation of PCT Application Serial No. PCT/EP2010/060568, filed on Jul. 21, 2010, which claims priority under 35 U.S.C. §119 to 10 2009 028 002.2 (DE), filed on Jul. 24, 2009. The disclosures PCT/EP2010/060568 and DE 10 2009 028 002.2 are hereby incorporated by reference in their entirety.

### FIELD OF THE INVENTION

The present invention is generally an auxiliary washing agent article, comprising a water-insoluble textile substrate and a bleach-containing auxiliary washing agent composition solidified on the substrate. The invention also relates to the use and to a method of producing the coated textile auxiliary washing agent article.

### BACKGROUND OF THE INVENTION

For severe stains, many consumers add an auxiliary washing agent to the washing solution in addition to the actual washing agent. This is often the case when the liquid washing agent does not contain any bleach.

Auxiliary washing agents are available to consumers today in many different presentations. In particular, auxiliary washing agents are available as powders or granules and generally contain bleach. However, for consumers who use liquid washing agents rather than powders, an auxiliary bleach-containing washing agent not in the form of powder or granules is preferred.

In view of the limited prior art, there is clearly an unmet need for a bleach-containing auxiliary washing agent article that, although not in a powdered or granular form, is still simple and convenient to add to the wash.

### SUMMARY OF THE INVENTION

It has now been surprisingly found that a convenient delivery of a bleach-containing auxiliary washing agent is possible by an auxiliary washing agent article comprising a water-insoluble textile substrate and a bleach-containing auxiliary washing agent composition solidified on the substrate, wherein the auxiliary washing agent composition comprises a film-forming polymer.

In further exemplary embodiments of the present invention, a washing additive cloth comprises a water-insoluble textile substrate and a bleach-containing auxiliary washing agent composition solidified thereon, wherein the washing agent composition includes a film-forming polymer into which the bleach is embedded.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

With that said, the present invention is generally an auxiliary washing agent article encompassing a water-insoluble textile substrate and a bleach-containing auxiliary washing agent composition solidified on the substrate, wherein the auxiliary washing agent composition comprises a film-forming polymer.

Such an auxiliary washing agent article has the desired advantages in terms of being easy to add in exact portions. By embedding the bleach in a film-forming polymer, the bleach particles are effectively fixed on the textile substrate and not subject to being rubbed off.

Since phthalimidoperoxoalkanoic acids, such as in particular 6-phthalimidoperoxohexanoic acid (PAP), are highly efficient bleaching agents, these are used as bleaching agents in a preferred embodiment of the invention. When phthalimidoperoxoalkanoic acids, and in particular PAP, are used, the quantity of bleaching agent in the present article may be kept relatively low. The result is that the auxiliary washing agent article itself does not become too stiff or rigid but remains flexible.

In a preferred embodiment of the invention, the film-forming polymer is selected from the group consisting of polyvinyl alcohol, high molecular-weight polyethylene glycol, polyvinylpyrrolidone, copolymers of vinylpyrrolidone and vinylimidazole, starch ethers, cellulose ethers, polyacrylates, and mixtures thereof.

These polymers form stable, continuous films and help to fix the auxiliary washing agent composition, together with the bleach particles contained therein, on the textile substrate. In addition, these polymers are water-soluble or water-dispersible. Some of the polymers have other effects. Thus, the use of polyvinylpyrrolidone or a copolymer of vinylpyrrolidone and vinylimidazole prevents dye transfer from darker textiles leading to discoloration and/or graying of other fabrics in the wash. Carboxymethyl cellulose prevents previously dissolved dirt, which has already been released from a textile during the pre-treatment and/or the washing process, from being redeposited on the same or another textile. Polyacrylates are used to soften the water and support the washing action through their alkalinity and by dissolving calcium and magnesium ions out of dirt/fiber bridges.

To improve the feel of the auxiliary washing agent articles, the article preferably contains a plasticizer for the film-forming polymer. Preferred plasticizers for the film-forming polymer are selected from the group consisting of 1,2-propanediol, 1,3-propanediol, ethylene glycol, diethylene glycol, 2,3-butanediol, triethyl citrate, paraffin oil, and mixtures thereof.

In another preferred embodiment, the bleach-containing auxiliary washing agent composition contains a further ingredient selected from the group consisting of surfactants, optical brighteners, bleach activators, bleach catalysts, enzymes, hydrocarbons, builders, perfumes, corrosion inhibitors, and mixtures thereof.

In another preferred embodiment, at least one further composition is present in solidified form on the substrate. In addition to the bleach-containing auxiliary washing agent composition solidified on the substrate, an additional composition may be present, such as for example a bleach-free auxiliary washing agent composition, and/or a textile-care composition. In this way the practical uses of the auxiliary washing agent article can be extended by additional functionality. In an auxiliary washing agent article of this type, generally incompatible ingredients of a washing agent can be placed together in one product as separate compositions on a single substrate.

The bleach-containing auxiliary washing agent composition may be a different color than any other washing agent composition present on the article, such that the consumer recognize visually that the coated textile auxiliary washing agent article includes multiple functionality.

It is preferred that the textile substrate comprise a woven or non-woven fabric. Woven and non-woven fabrics are very strong and hard-wearing, so that these textile substrates withstand the high mechanical stresses during the washing process, in particular in a washing machine.

It may be preferred that the bleach-containing auxiliary washing agent composition and the additional compositions are arranged adjacent to one another on the textile substrate.

In another preferred embodiment, the bleach-containing auxiliary washing agent composition and the rest of the composition are arranged at least partially overlapping on the textile substrate.

Through the different arrangement of the compositions, different dissolving profiles and thus release profiles of the ingredients contained can be set up for the respective compositions.

The invention also relates to the use of an auxiliary washing agent article according to the invention for the pre-treatment and/or washing of laundry.

Furthermore, the invention relates to a method for the pre-treatment and/or the washing of laundry by machine or by hand using an auxiliary washing agent article encompassing a water-insoluble textile substrate and a bleach-containing auxiliary washing agent composition solidified on the substrate and wherein the auxiliary washing agent composition comprises a film-forming polymer.

The invention also provides a method of producing an auxiliary washing agent article, encompassing a water-insoluble textile substrate and a bleach-containing auxiliary washing agent composition, which is present in solidified form on the substrate, encompassing the steps of producing a free-flowing, bleach-containing auxiliary washing agent composition with a film-forming polymer, providing a textile substrate, applying the free-flowing, bleach-containing auxiliary washing agent composition onto at least one area of the textile substrate, and allowing the bleach-containing auxiliary washing agent composition to cool and solidify on the substrate.

The invention will be explained in more detail below, inter alia by the presentation of examples.

The auxiliary washing agent article according to the invention encompasses a water-insoluble textile substrate and a bleach-containing auxiliary washing agent composition solidified thereon.

Suitable textile substrates include, but are not limited to, non-woven fabrics and woven fabrics, preferably comprised of cellulose (for example cotton), viscose, polyester, polyethylene, polypropylene, polyethylene terephthalate, polybutylene terephthalate, nylon, rayon, and/or polyacrylic.

The dimensions of the textile substrate may be about 10 cm×10 cm, or 15 cm×15 cm, although other sizes that still permit easy handling are also conceivable. The textile substrate and thus the auxiliary washing agent article can be of any flat shape, for example square, rectangular, triangular, circular, oval, heart-shaped, in the shape of letters or words, or corresponding to the reproduction of a trade mark. The textile substrate can be of any color or substantially white; its surface can be substantially smooth or textured as a result of its manufacture. The textile substrate, and thus the auxiliary washing agent article, preferably has a surface area (based on one side) of 40 cm² to 800 cm². In one embodiment of the invention, the textile substrate is roughened on at least parts of its surface and thus exhibits a surface detail.

In another preferred embodiment, the textile substrate has a finish. The term “finish” in the context of this application is understood as a short-term or permanent, chemical and/or physical change to the water-insoluble substrate, which provides this with particular use properties such as, for example, dye-trapping properties, dirt-trapping properties or antimicrobial action. This change can be made to the fibers that are later used in the manufacture of the water-insoluble textile substrate, or may be made to the water-insoluble textile substrate after its manufacture.

The finishing of the fibers can take place, for example, by means of a “direct” method in which the fibers are treated with an application liquor, i.e. for example with a solution, dispersion, or other form of a color-trapping and/or dirt-trapping compound. During the treatment, the color-trapping and/or dirt-trapping compound used is absorbed evenly from the application liquor onto the fibers being treated. Alternatively, the water-insoluble textile substrate can also be immersed in the application liquor or printed or sprayed with the treatment compound. The antimicrobial finish can take place, for example, by incorporating silver threads during the production of the textile substrate or by applying silver compounds, such as for example SILVERPLUS® (ex Rudolf Chemie).

A bleach-containing auxiliary washing agent composition is found as a solid composition, solidified on the textile substrate.

The auxiliary washing agent composition necessarily contains a bleaching agent.

Suitable as bleaching agents for use in auxiliary washing agent articles according to the invention are, in particular, organic per acids or per acid salts of organic acids, such as perbenzoic acid or salts of diperdodecanoic diacid, and inorganic salts that give off hydrogen peroxide under the washing conditions. These include, but are not limited to, alkali perborate, alkali percarbonate, persilicate and/or persulfate, such as Caroat.

The auxiliary washing agent composition preferably contains a phthalimidoperoxoalkanoic acid. For example, 4-phthalimidoperoxobutanoic acid, 5-phthalimidoperoxopentanoic acid, 6-phthalimidoperoxohexanoic acid, 7-phthalimidoperoxoheptanoic acid, N,N′-terephthaloyl-di-6-aminoperoxohexanoic acid and mixtures of these are suitable. The preferred phthalimidoperoxoalkanoic acids include 6-phthalimidoperoxohexanoic acid (PAP).

The phthalimidoperoxoalkanoic acid particles can have a coating. In this case, it is important that the coating material releases the encapsulated peroxocarboxylic acid under the application conditions of the auxiliary washing agent article (at elevated temperature, pH that changes by dilution with water, or similar). A preferred coating material is one that consists at least in part of saturated fatty acid. The chain length of the fatty acid is preferably greater than C₁₂, with stearic acid being particularly preferred.

Furthermore, the addition of small quantities of known bleaching agent stabilizers, such as for example of phosphonates, borates or metaborates and metasilicates, and magnesium salts, such as magnesium sulfate, may be useful.

The bleach-containing auxiliary washing agent composition preferably contains 5 wt. % to 95 wt. %, in particular 10 wt. % to 90 wt. %, of bleaching agent. The total quantity of bleaching agent is preferably between 0.1 g and 20 g, preferably between 0.5 and 15 g, and is particularly preferably between 1 g and 10 g. In addition to the bleaching agent, the bleach-containing auxiliary washing agent composition can contain bleach activator and/or a bleach-enhancing transition metal complex, but it can also be free from these. Preferably, at least one of the other compositions contains bleach activator and/or a bleach-enhancing transition metal complex.

In particular, compounds that give aromatic or aliphatic peroxocarboxylic acids under perhydrolysis conditions can be used as bleach activators. Polyacylated alkylenediamines, in particular tetraacetyl ethylenediamine (TAED), acylated triazine derivatives, in particular 1,5-diacetyl-2,4-dioxohexahydro-1,3,5-triazine (DADHT), acylated glycolurils, in particular tetraacetyl glycoluril (TAGU), N-acylimides, in particular N-nonanoyl succinimide (NOSI), acylated phenolsulfonates, in particular n-nonanoyl or isononanoyl oxybenzenesulfonate (n- or iso-NOBS), carboxylic acid anhydrides, in particular phthalic anhydride, and acylated polyhydric alcohols, in particular triacetin, ethylene glycol diacetate and 2,5-diacetoxy-2,5-dihydrofuran, are preferred. Nitriles forming perimidic acids under perhydrolysis conditions, for example acetonitries carrying ammonium groups, can also be used.

In addition to the conventional bleach activators or instead of them, so-called bleach catalysts can also be incorporated. These substances are bleach-enhancing transition metal salts or transition metal complexes, such as for example Mn-, Fe-, Co-, Ru- or Mo-salene complexes or carbonyl complexes. Mn, Fe, Co, Ru, Mo, Ti, V and Cu complexes with nitrogen-containing tripod ligands and Co-, Fe-, Cu- and Ru-amine complexes can be used as bleach catalysts. The preferred bleach catalysts include complexes with triazacyclononane ligands, which may optionally also be mono- or polyalkyl-substituted, for example 1,4,7-trimethyl-1,4,7-triazacyclononane.

In addition, the bleach-containing auxiliary washing agent composition contains a film-forming polymer as an essential component. This polymer is preferably selected from the group consisting of polyvinyl alcohol, high molecular-weight polyethylene glycol, polyvinylpyrrolidone, copolymers of vinylpyrrolidone and vinylimidazole, carboxymethyl cellulose, polyacrylates, and mixtures thereof.

The polyvinyl alcohols can, for example, be polyvinyl alcohols produced by a partial saponification of polyvinyl acetate with a saponification value (=mg KOH required to saponify the remaining acetyl groups) of 150 to 240 and a molecular weight of 15,000 to 100,000, determined by viscometry.

Suitable polyethylene glycols have a molecular weight in the range of 2,000 to 10,000.

The use of polyvinylpyrrolidone (PVP) or copolymers of vinylpyrrolidone and vinylimidazole (PVP/PVI) as film-forming polymers has the advantage that the polymers not only fix the bleach particles of the auxiliary washing agent composition on the textile substrate, but they also act as dye transfer inhibitors during use of the auxiliary washing agent article. The polyvinylpyrrolidones (PVPs) used preferably have an average molecular weight of 2,500 to 400,000 and are commercially available from ISP Chemicals as PVP K 15, PVP K 30, PVP K 60 or PVP K 90, or from BASF as Sokalan® HP 50 or Sokalan HP 53. The copolymers of vinylpyrrolidone and vinylimidazole (PVP/PVI) used preferably have a molecular weight in the range of 5,000 to 100,000. A PVP/PVI copolymer is commercially available, for example, from BASF under the name Sokalan® HP 56.

Suitable cellulose ethers include, for example, methyl cellulose, hydroxyethyl cellulose, hydroxypropyl cellulose, methyl hydroxypropyl cellulose or carboxymethyl cellulose. When these cellulose ethers are used and, in particular, when the salt of carboxymethyl cellulose is used as film-forming polymer, the auxiliary washing agent article also has a graying-inhibiting action.

Through the use of polyacrylates, such as polyacrylic acid or acrylic acid/maleic acid copolymers as film-forming polymer, the auxiliary washing agent article additionally has a water-softening effect.

The film-forming polymers are used in quantities of 5 to 35 wt. %, based on the overall auxiliary washing agent composition.

So that the auxiliary washing agent articles in the form of coated textile substrates do not become too stiff, but rather exhibit flexibility, it is preferred for the bleach-containing auxiliary washing agent composition to contain a plasticizer for the film-forming polymer. Suitable plasticizers include, for example, 1,2-propanediol, 1,3-propanediol, ethylene glycol, diethylene glycol, 2,3-butanediol, triethyl citrate, paraffin oil, and mixtures thereof.

The bleach-containing auxiliary washing agent composition to be applied onto the textile substrate, (particularly if it is to be applied as a melt), preferably contains components that are solid or waxy at room temperature but which can melt at a higher temperature. Ingredients that may be melted include in particular surfactants. In addition, ingredients that are conventionally found in washing agents or laundry post-treatment agents can be included in the auxiliary washing agent composition of the present invention.

A bleach-containing auxiliary washing agent composition to be applied onto the textile substrate according to the invention can contain in particular surfactants, optical brighteners, bleach activators, bleach catalysts, enzymes, hydrocarbons, builders, perfumes, corrosion inhibitors and mixtures thereof as further ingredients.

The bleach-containing auxiliary washing agent composition to be applied to the substrate may contain one or more surfactants. Preferred surfactants are the anionic surfactants, nonionic surfactants, and mixtures thereof, but may also include cationic surfactants. Suitable nonionic surfactants are, in particular, alkyl glycosides and ethoxylation and/or propoxylation products of alkyl glycosides or linear or branched alcohols with in each case 12 to 18 carbon atoms in the alkyl portion and 3 to 20, preferably 4 to 10 alkyl ether groups. It is also possible to use corresponding ethoxylation and/or propoxylation products of N-alkylamines, vicinal diols, fatty acid esters and fatty acid amides, which correspond to the said long-chain alcohol derivatives in terms of the alkyl portion, and of alkyl phenols with 5 to 12 carbon atoms in the alkyl residue.

Suitable anionic surfactants include soaps and those anionic surfactants comprising a sulfate or sulfonate group with alkali ions as the preferred cations. Soaps that find use include the alkali salts of saturated or unsaturated fatty acids having from 12 to 18 carbons. Fatty acids of this type can also be used in incompletely neutralized form. The surfactants of the sulfate type that can be used include the salts of the sulfuric acid semiesters of fatty alcohols with 12 to 18 carbon atoms, and the sulfation products of the aforementioned nonionic surfactants having a low degree of ethoxylation. The surfactants of the sulfonate type that can be used include linear alkylbenzene sulfonates with 9 to 14 carbon atoms in the alkyl portion, alkane sulfonates with 12 to 18 carbon atoms, and olefin sulfonates with 12 to 18 carbon atoms, which are formed during the reaction of corresponding monoolefins with sulfur trioxide, and α-sulfo fatty acid esters, which are formed during the sulfonation of fatty acid methyl or ethyl esters.

Surfactants of this type are contained in the bleach-containing auxiliary washing agent composition to be applied onto the textile substrate according to the invention in quantities of preferably 1 wt. % to 25 wt. %, and in particular of 5 wt. % to 15 wt. %, based on the weight of the washing agent composition.

Through the presence of another composition, also present in solidified form on the textile substrate, the auxiliary washing agent article can be provided with other functionalities. In particular, additional compositions on the substrate may contain ingredients that are incompatible with the ingredients used in the bleach-containing auxiliary washing agent composition, or ingredients which should only come into contact with ingredients of the bleach-containing auxiliary washing agent composition in the washing liquor. Ingredients in any additional compositions on the substrate may be selected from the group consisting of surfactants, optical brighteners, bleach activators, bleach catalysts, enzymes, hydrocarbons, builders, perfumes, and mixtures thereof.

An additional composition present on the substrate may be another, bleach-free auxiliary washing agent composition, for example having a different dissolution profile from the first bleach-containing auxiliary washing agent composition, such that the release of ingredients from the bleach-free composition is at a later time in the washing process. This delayed release is particularly useful when the additional bleach-free washing agent composition includes enzymes.

In an exemplary embodiment, the bleach-containing auxiliary washing agent composition and any additional compositions present may be at least partially overlapping on the textile substrate.

In an alternative embodiment, the bleach-containing auxiliary washing agent composition and any other compositions present are arranged adjacent to one another on the textile substrate.

In a preferred embodiment, the bleach-containing auxiliary washing agent composition is colored differently from any other compositions that may be present on the article.

It is important to realize that the entire available surface of the textile substrate need not be covered with the solidified bleach-containing auxiliary washing agent composition and any optional compositions, provided that the bleach-containing auxiliary washing agent composition resides in one area in at least one part of the substrate surface.

The bleach-containing auxiliary washing agent composition, and any additional compositions optionally present, may be applied onto only one side or both sides of the textile substrate. The bleach-containing auxiliary washing agent composition, and the additional composition(s) optionally present, is preferably applied onto only one side of the textile substrate. This practice has the advantage that the consumer has an uncoated surface to handle and does not have to come into direct contact with any of the compositions when using the present article.

It is possible to apply the bleach-containing auxiliary washing agent composition onto the textile substrate as a liquid solution, slurry or paste, and then perform a drying step to drive off the water and/or solvents present. In this case, the composition solidifies on the substrate by drying. Alternatively, the bleach-containing auxiliary washing agent composition may be applied onto the textile substrate as a heated melt, which is then allowed to solidify by cooling. In this case, not all of the bleach-containing auxiliary washing agent composition has to be present in liquefied form by melting. That is, the melt may contain particulate ingredients that do not melt or dissolve in the heated melt. Such non-melting ingredients may include inorganic builders.

### EXAMPLE

As a first step, commercially available aqueous PAP dispersion (Euroco® LX from Solvay) was centrifuged. After decanting off the supernatant, the PAP particles were slurried with distilled water and centrifuged again. The PAP paste obtained had an active substance content of 45%, determined iodometrically. This PAP paste is the ingredient used below.

TABLE 1 shows the composition of a bleach-containing auxiliary washing agent composition in accordance with the present invention before it is applied onto a textile substrate. In TABLE 1, each of the quantities of ingredients are listed in weight percent (wt. %) active substance, based on the total weight of the composition.

TABLE 1
Bleach-containing auxiliary washing agent composition.

| Ingredients | wt. % |
|---|---|
| PAP paste (in accordance | 35 |
| with above preparation) | |
| Acrylic acid/maleic acid | 5 |
| copolymer, sodium salt | |
| Liquid paraffin | 8 |
| Water | q.s. |

To produce the bleach-containing auxiliary washing agent composition shown in Table 1, the polyacrylate and the paraffin were slowly stirred into the PAP paste. 5.71 g of the homogeneous paste obtained were poured onto a non-woven fabric of polyester measuring 100 mm×50 mm, and distributed. The prepared non-woven fabric was dried for 30 minutes at 35° C.

After 4 weeks of storage at room temperature, the content of PAP was still greater than 90%.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

We claim:

1. An auxiliary washing agent article comprising:
a. a water-insoluble textile substrate; and
b. a bleach-containing auxiliary washing agent composition solidified on said substrate; and
wherein said bleach-containing auxiliary washing agent composition comprises a film-forming polymer.

2. The auxiliary washing agent article of claim 1, wherein said textile substrate is a woven fabric or a non-woven fabric.

3. The auxiliary washing agent article of claim 1, wherein said bleach-containing auxiliary washing agent composition contains a phthalimidoperoxoalkanoic acid.

4. The auxiliary washing agent article of claim 3, wherein said phthalimidoperoxoalkanoic acid is 6-phthalimidoperoxohexanoic acid.

5. The auxiliary washing agent article of claim 1, wherein said film forming polymer is selected from the group consisting of polyvinyl alcohol, high molecular-weight polyethylene glycol, polyvinylpyrrolidone, starch ethers, cellulose ethers, polyacrylates, and mixtures thereof.

6. The auxiliary washing agent article of claim 1, wherein said bleach-containing auxiliary washing agent composition further contains a plasticizer for the film-forming polymer.

7. The auxiliary washing agent article of claim 6, wherein said plasticizer is selected from the group consisting of 1,2-propanediol, 1,3-propanediol, ethylene glycol, diethylene glycol, 2,3-butanediol, triethyl citrate, paraffin oil, and mixtures thereof.

8. The auxiliary washing agent article of claim 1, wherein said bleach-containing auxiliary washing agent composition contains a further ingredient selected from the group consisting of surfactants, optical brighteners, bleach activators, bleach catalysts, enzymes, hydrocarbons, builders, perfumes, corrosion inhibitors, and mixtures thereof.

9. The auxiliary washing agent article of claim 1 further including an additional composition solidified on said substrate.

10. The auxiliary washing agent article of claim 9, wherein said additional composition is a different color than said bleach-containing auxiliary washing agent composition.

11. The auxiliary washing agent article of claim 9, wherein said bleach-containing auxiliary washing agent composition and said additional composition are adjacent to one another on said substrate.

12. The auxiliary washing agent article of claim 9, wherein said bleach-containing auxiliary washing agent composition and said additional composition are at least partially overlapping one another on said substrate.

13. Use of the auxiliary washing agent article of claim 1 for the pre-treatment or washing of laundry.

14. A method pre-treatment or washing of laundry by machine or hand using an auxiliary washing agent article, said method comprising the step of adding the auxiliary washing agent article of claim 1 to a laundry machine.

15. A method for manufacturing the auxiliary washing agent article of claim 1, said method comprising the steps of:
a. providing said textile substrate;
b. providing said bleach-containing auxiliary washing agent composition in a liquid and free-flowing form;
c. applying said bleach-containing auxiliary washing agent composition onto at least one area of said textile substrate; and
d. drying said composition onto said substrate.

16. A method for manufacturing the auxiliary washing agent article of claim 1, said method comprising the steps of:
a. providing said textile substrate;
b. providing said bleach-containing auxiliary washing agent composition in a heated melt form;
c. applying said bleach-containing auxiliary washing agent composition onto at least one area of said textile substrate; and
d. allowing said composition to cool into a solid on said substrate.
